(19) United States
(12) Patent Application Publication
(10) Pub. No.: US 2019/0279365 A1
(43) Pub. Date: Sep. 12, 2019

(54) IMAGING APPARATUS

(71) Applicant: OMRON Corporation, Kyoto-shi (JP)

(72) Inventors: Takahiro SAKUMA, Komaki-shi (JP); Yoshio MATSUURA, Komaki-shi (JP)

(73) Assignee: OMRON Corporation, Kyoto-shi (JP)

(21) Appl. No.: 16/283,883

(22) Filed: Feb. 25, 2019

(30) Foreign Application Priority Data
Mar. 7, 2018 (JP) 2018-40311

(51) Int. Cl. G06T 7/11; G06T 7/00; B60R 11/04; B60W 50/14; B60W 40/09

(52) U.S. Cl. CPC G06T 7/11; G06T 7/0002; G06T 7/97; G06T 2207/20021; B60W 50/14; B60W 40/09; G06T 2207/10016; B60R 11/04

(57) ABSTRACT

An imaging apparatus accurately detects an obstacle interfering with image capturing as distinguishable from an obstacle not interfering with image capturing. An image captured by an imaging unit is divided into a plurality of sections, and the captured image is divided into a plurality of blocks each including a predetermined number of sections. For each of the blocks, an obstructed state of each section in each of the blocks is checked. When the obstructed state of each section in at least one block interferes with image capturing of the subject (when at least a part of the central area is obstructed), an obstacle between the imaging unit and the subject is detected.

### CROSS-REFERENCE TO RELATED APPLICATION

This application claims priority to Japanese Patent Application No. 2018-040311 filed on Mar. 7, 2018, the entire disclosure of which is incorporated herein by reference.

### FIELD

The present invention relates to an imaging apparatus such as an on-vehicle driver monitor, and more particularly, to a technique for detecting an obstacle interfering with capturing of a subject image.

### BACKGROUND

An on-vehicle driver monitor analyzes an image of a driver's face captured by a camera, and monitors whether the driver is falling asleep during driving or the driver is engaging in distracted driving based on the opening degree of the eyelids or the gaze direction. The camera for the driver monitor is typically installed on the dashboard in front of the driver's seat, along with the display panel and instruments.

However, the camera is a small component, and can be blocked by an object on the dashboard hanging over the camera (e.g., a towel), which may be overlooked by the driver. The camera may also be blocked by an object suspended above the driver's seat (e.g., an insect) or by a sticker attached to the camera by a third person. The blocked camera cannot capture an image of the driver's face, failing to correctly monitor the state of the driver.

Patent Literatures 1 and 2 each describe an imaging apparatus that deals with an obstacle between the camera and the subject. The technique in Patent Literature 1 defines, in an imaging area, a first area for capturing the subject and a second area including the first area. When the second area includes an obstacle hiding the subject, the image capturing operation is stopped to prevent the obstacle from appearing in a captured image. The technique in Patent Literature 2 notifies, when an obstacle between the camera and the face obstructs the detection of facial features in a captured image, the user of the undetectable features as well as the cause of such unsuccessful detection and countermeasures to be taken.

Obstacles may prevent the camera from capturing images in various manners. The field of view (imaging area) of the camera may be obstructed entirely or partially. Although an obstacle entirely blocking the field of view prevents the camera from capturing a face image, an obstacle partially blocking the field of view does or does not prevent the camera from capturing a face image.

For example, a camera that captures the face in a central area of its field of view cannot capture the overall face when the central area is entirely or partially blocked by an obstacle. However, the camera can still capture the overall face when an obstacle merely blocks a peripheral area around the central area. In this case, the obstacle detected between the camera and the face does not interfere with capturing of the face. In this state, the processing performed in response to obstacle detection (e.g., an alarm output) will place an additional burden on the apparatus as well as provides incorrect information to the user.

### CITATION LIST

### Patent Literature

Patent Literature 1: Japanese Unexamined Patent Application Publication No. 2013-205675

Patent Literature 2: Japanese Unexamined Patent Application Publication No.

2009-296355

### SUMMARY

### Technical Problem

One or more aspects of the present invention are directed to an imaging apparatus that accurately detects an obstacle interfering with image capturing as distinguishable from an obstacle not interfering with image capturing.

### Solution to Problem

An imaging apparatus according to one aspect of the present invention includes an imaging unit that captures an image of a subject, an image processor that processes the image captured by the imaging unit, and an obstacle detector that detects an obstacle between the imaging unit and the subject based on the captured image processed by the image processor. The image processor divides the image captured by the imaging unit into a plurality of sections, and divides the captured image into a plurality of blocks each including a predetermined number of sections. The obstacle detector checks an obstructed state of each section in each of the blocks, and the obstacle detector detects the obstacle when the obstructed state of each section in at least one block interferes with image capturing of the subject.

In this aspect of the present invention, the obstructed state of each block is checked to detect any obstacle interfering with image capturing between the imaging unit and the subject. Such checking detects no obstacle when an obstacle between the imaging unit and the subject does not interfere with image capturing. This enables an obstacle interfering with image capturing to be accurately detected as distinguishable from an obstacle not interfering with image capturing.

In the above aspect of the present invention, the obstacle detector may detect the obstacle when all the sections in at least one block are obstructed.

In the above aspect of the present invention, each of the blocks may include a part of a specific area containing a specific part of the subject in the captured image.

In this case, the obstacle detector may detect the obstacle when at least one section in the specific area is obstructed.

The obstacle detector may detect no obstacle when all the sections in the specific area are unobstructed.

In the above aspect of the present invention, the specific part may be a face of the subject, and the specific area may be a central area of the captured image.

In the above aspect of the present invention, the obstacle detector may detect the obstacle when all the sections in at least one block are obstructed, and may detect no obstacle when a predetermined section in each of the blocks is unobstructed.

In the above aspect of the present invention, the obstacle detector may compare luminance of a plurality of pixels included in one section with a threshold pixel by pixel, and the obstacle detector may determine that a section including at least a predetermined number of pixels with a result of comparison satisfying a predetermined condition is an obstructed section.

In the above aspect of the present invention, the image processor may define an area excluding side areas of the captured image as a valid area, and the image processor may divide the captured image within the valid area into a plurality of sections.

In the above aspect of the present invention, the obstacle detector may output a notification signal for removing the obstacle when detecting the obstacle.

In the above aspect of the present invention, the imaging unit may be installed in a vehicle to capture a face image of an occupant of the vehicle, and the obstacle detector may detect an obstacle between the imaging unit and the face of the occupant.

### Advantageous Effects

The imaging apparatus according to the above aspects of the present invention accurately detects an obstacle interfering with image capturing as distinguishable from an obstacle not interfering with image capturing.

### BRIEF DESCRIPTION OF THE DRAWINGS

FIG. 1 is an electrical block diagram of a driver monitor according to an embodiment of the present invention.

FIG. 2 is a diagram describing a driver monitor capturing a face image.

FIG. 3 is a diagram describing section division and block division in the captured image.

FIG. 4 is a diagram describing image areas after the division.

FIGS. 5A to 5C are diagrams describing obstructed states in which no obstacle is detected.

FIGS. 6A to 6C are diagrams describing obstructed states in which an obstacle is detected.

FIG. 7 is an example captured image including an obstacle.

FIG. 8 is a flowchart of an obstacle detection procedure.

FIG. 9 is a flowchart of another example of the obstacle detection procedure.

FIGS. 10AA to 10AC are diagrams describing other examples in which obstacles are detected.

FIGS. 10BA to 10BC are diagrams describing still other examples in which obstacles are detected.

FIG. 11 is a diagram describing another example of the section division.

FIG. 12 is a diagram describing another example of the block division.

### DETAILED DESCRIPTION

Embodiments of the present invention will be described with reference to the drawings. The same or corresponding components are given the same reference numerals in the figures. In the example below, the present invention is applied to an on-vehicle driver monitor.

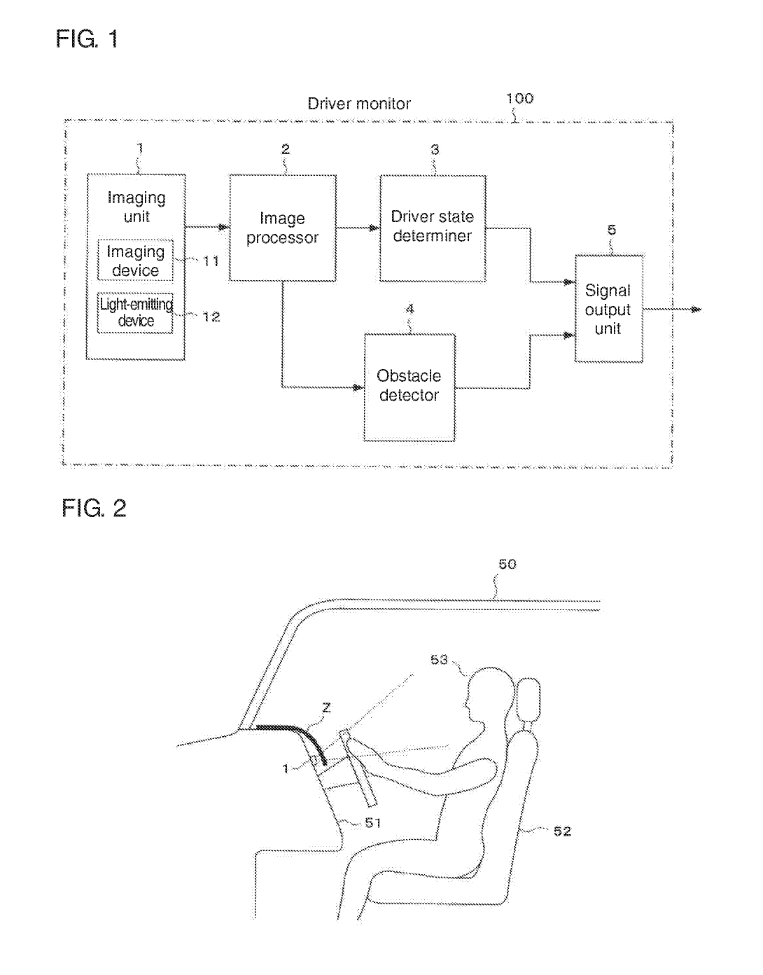

The configuration of the driver monitor will now be described with reference to FIGS. 1 and 2. FIG. 1 shows a driver monitor 100 installed in a vehicle 50 shown in FIG. 2. The driver monitor 100 includes an imaging unit 1, an image processor 2, a driver state determiner 3, an obstacle detector 4, and a signal output unit 5.

The imaging unit 1 is a camera, and includes an imaging device 11 and a light-emitting device 12. The imaging device 11 is, for example, a complementary metal-oxide semiconductor (CMOS) image sensor, and captures an image of the face of a driver 53, who is a subject in a seat 52. The light-emitting device 12 is, for example, a light emitting diode (LED) that emits near-infrared light, and illuminates the face of the driver 53 with near-infrared light. As shown in FIG. 2, the imaging unit 1 is installed on a dashboard 51 adjacent to the driver's seat of the vehicle 50 to face the face of the driver 53.

The image processor 2 processes an image captured by the imaging unit 1. The processing will be described in detail later. The driver state determiner 3 determines the state of the driver 53 (e.g., falling-asleep or being distracted) based on the image processed by the image processor 2. The obstacle detector 4 detects an obstacle between the imaging unit 1 and the driver 53 based on the image processed by the image processor 2 with a method described later. FIG. 2 shows an obstacle Z placed on the dashboard 51, such as a towel or a print.

The signal output unit 5 outputs a signal based on the determination results from the driver state determiner 3 and a signal based on the detection results from the obstacle detector 4. The output signals are transmitted to an electronic control unit (ECU) (not shown) installed in the vehicle 50 through a Controller Area Network (CAN).

Although the functions of the image processor 2, the driver state determiner 3, and the obstacle detector 4 in FIG. 1 are actually implemented by software, FIG. 1 shows these units as functional blocks for convenience.

A method used by the obstacle detector 4 for detecting the obstacle Z will now be described.

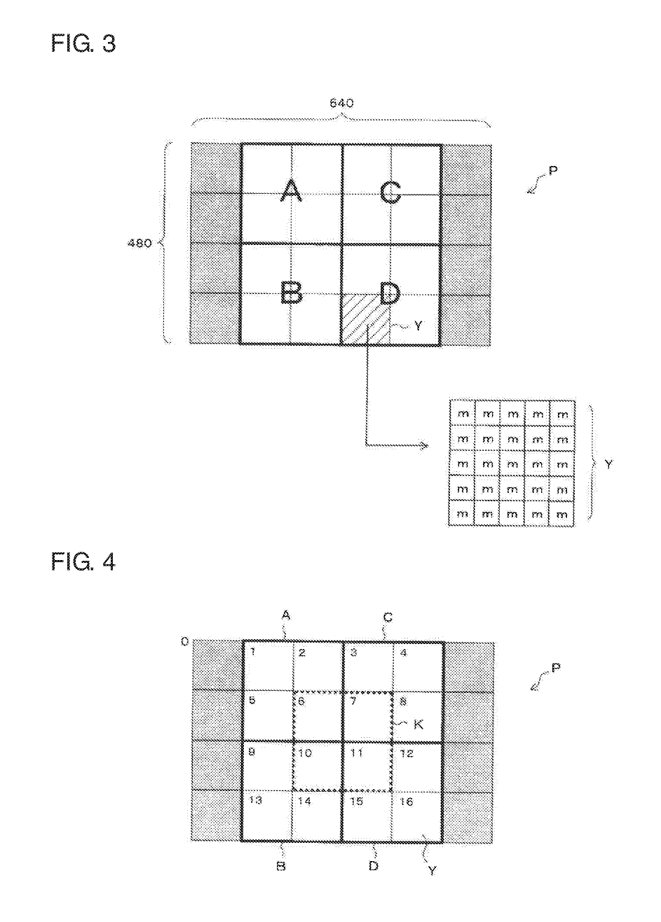

FIG. 3 schematically shows an image P captured by the imaging unit 1.

The captured image P in this example includes 640 by 480 pixels. The captured image P is first divided into 16 sections Y. In this case, the area excluding the side areas (solid filled parts) of the captured image P is defined as a valid area, which is then divided into 16 sections Y. The side areas are excluded because any obstacle captured within such areas will not interfere with capturing of a face image. A single section Y includes multiple pixels m.

The captured image P is then divided into four blocks A, B, C, and D, each of which includes four of the 16 divided sections Y. For convenience, the 16 sections Y are individually given numbers 1 to 16 as shown in FIG. 4. In the example described below, the section with number 1 is written as section #1, the section with number 2 is written as section #2, and other sections are expressed likewise.

Block A includes four sections #1, #2, #5, and #6. Block B includes four sections #9, #10, #13, and #14. Block C includes four sections #3, #4, #7, and #8. Block D includes four sections #11, #12, #15, and #16.

FIG. 4 shows a square area K indicated by the dotted lines, and the square area K is a specific area containing a specific part of the subject. In the present embodiment, the subject is the driver 53, the specific part is the face of the driver 53, and the specific area is the central area K in the captured image P. More specifically, the central area K includes the face of the driver 53, and the face image of the driver 53 is captured within the central area K. The central area K includes four sections #6, #7, #10, and #11. Thus, four blocks A to D each include a part of the central area K.

In FIG. 4, sections #1 to #4 mainly include the interior of the vehicle, and sections #14 and #15 mainly include the clothes on the upper body of the driver 53. Four blocks A to D each include at least one of those sections.

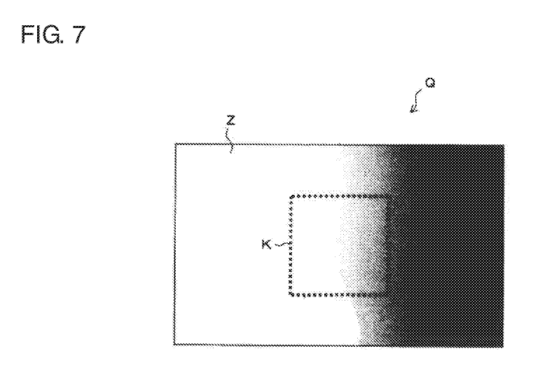

To detect an obstacle, the obstructed state of each of the four sections included in one block is checked first. More specifically, the obstacle detector 4 compares the luminance of every pixel m included in each section with a threshold pixel by pixel, and extracts a pixel with a comparison result satisfying a predetermined condition, or more specifically, a pixel with a luminance value higher than the threshold. Referring to a captured image Q shown in FIG. 7, an obstacle Z within an imaging area appears white under near-infrared light applied from the light-emitting device 12, and the area corresponding to the obstacle Z has high luminance. In this state, a section with at least half of all the pixels m having luminance values higher than the threshold is determined to be an obstructed section. The determination is performed for all blocks A to D.

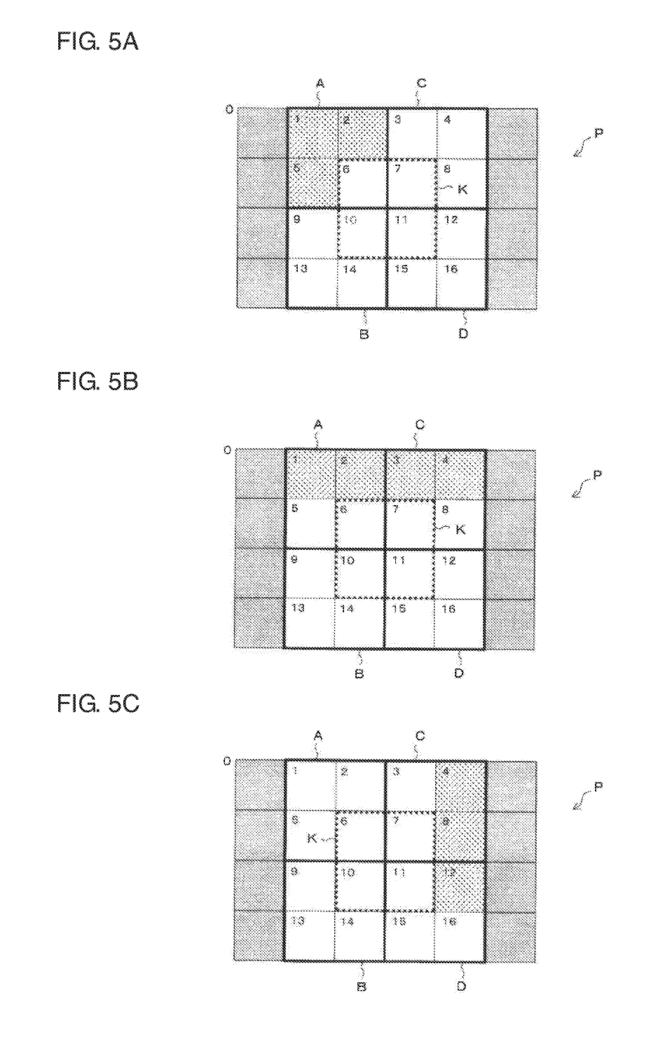

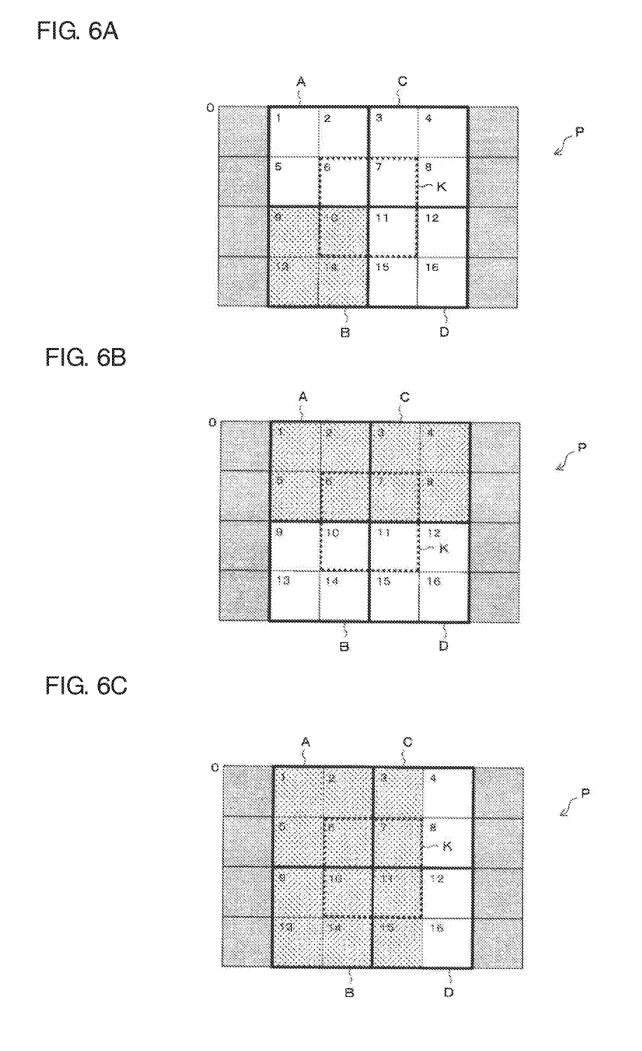

Then, the obstacle detector 4 determines whether the obstructed states of the sections in each block A to D interfere with image capturing of the subject. In the present embodiment, the obstacle detector 4 determines whether all the four sections in each block are obstructed. FIGS. 5A to 5C and 6A to 6C show example obstructed states of each block. In these figures, hatched sections represent obstructed sections.

FIGS. 5A to 5C show example obstructed states that do not interfere with image capturing of the subject. In each block, merely a part of the four sections is obstructed.

In FIG. 5A, sections #1, #2, and #5 in block A are obstructed, whereas section #6 is unobstructed. In FIG. 5B, sections #1 and #2 in block A are obstructed, whereas sections #5 and #6 are unobstructed. In addition, sections #3 and #4 in block C are obstructed, whereas sections #7 and #8 are unobstructed. In FIG. 5C, sections #4 and #8 in block C are obstructed, whereas sections #3 and #7 are unobstructed. In addition, section #12 in block D is obstructed, whereas sections #11, #15, and #16 are unobstructed.

FIG. 5A shows an example in which an obstacle enters the imaging area from diagonally above and causes sections #1, #2, and #5 to be in an obstructed state. FIG. 5B shows an example in which an obstacle enters the imaging area from above and cause sections #1 to #4 to be in an obstructed state. FIG. 5C shows an example in which an obstacle enters the imaging area from the side and causes sections #4, #8, and #12 to be in an obstructed state.

In any of the examples shown in FIGS. 5A to 5C, an obstacle included in the imaging area has yet to enter the central area K, and sections #6, #7, #10, and #11 included in the central area K are all unobstructed. In this state, the central area K can capture the face, and thus the obstacle in this case does not interfere with image capturing of the subject. For all blocks A to D, when sections #6, #7, #10, and #11 corresponding to the central area K in the respective blocks are unobstructed, or when the entire central area K is unobstructed, the obstacle detector 4 detects no obstacle.

FIGS. 6A to 6C show example obstructed states that interfere with image capturing of the subject. In these examples, all the four sections of each block are obstructed.

In FIG. 6A, sections #9, #10, #13, and #14 in block B are all obstructed. In FIG. 6B, sections #1, #2, #5, and #6 in block A are all obstructed. In addition, sections #3, #4, #7, and #8 in block C are all obstructed. In FIG. 6C, sections #1, #2, #5, and #6 in block A are all obstructed, and sections #9, #10, #13, and #14 in block B are also all obstructed.

FIG. 6A shows an example in which an obstacle enters the imaging area from diagonally below and causes sections #9, #10, #13, and #14 to be in an obstructed state. FIG. 6B shows an example in which an obstacle enters the imaging area from above and causes sections #1 to #8 to be in an obstructed state. FIG. 6C shows an example in which an obstacle enters the imaging area from the side and causes sections #1 to #3, #5 to #7, #9 to #11, and #13 to #15 to be in an obstructed state.

In FIG. 6A, all the sections in block B are obstructed, and thus a part of the central area K (section #10) is also obstructed. In FIG. 6B, all the sections in blocks A and C are obstructed, and thus a part of the central area K (sections #6 and #7) is also obstructed. In FIG. 6C, all the sections in blocks A and B are obstructed, and thus a part of the central area K (sections #6 and #10) is also obstructed. In addition, sections #7 and #11 in blocks C and D are obstructed, and thus the entire central area K is obstructed.

In any of the examples shown in FIGS. 6A to 6C, an obstacle has entered the central area K. In this state, the central area K cannot accurately capture the face, and thus the obstacle in this case interferes with image capturing. When all the sections in at least one of blocks A to D are obstructed to block at least a part of the central area K, the obstacle detector 4 detects an obstacle. In FIG. 6C, blocks C and D, each of which includes unobstructed sections, are not used for obstacle detection.

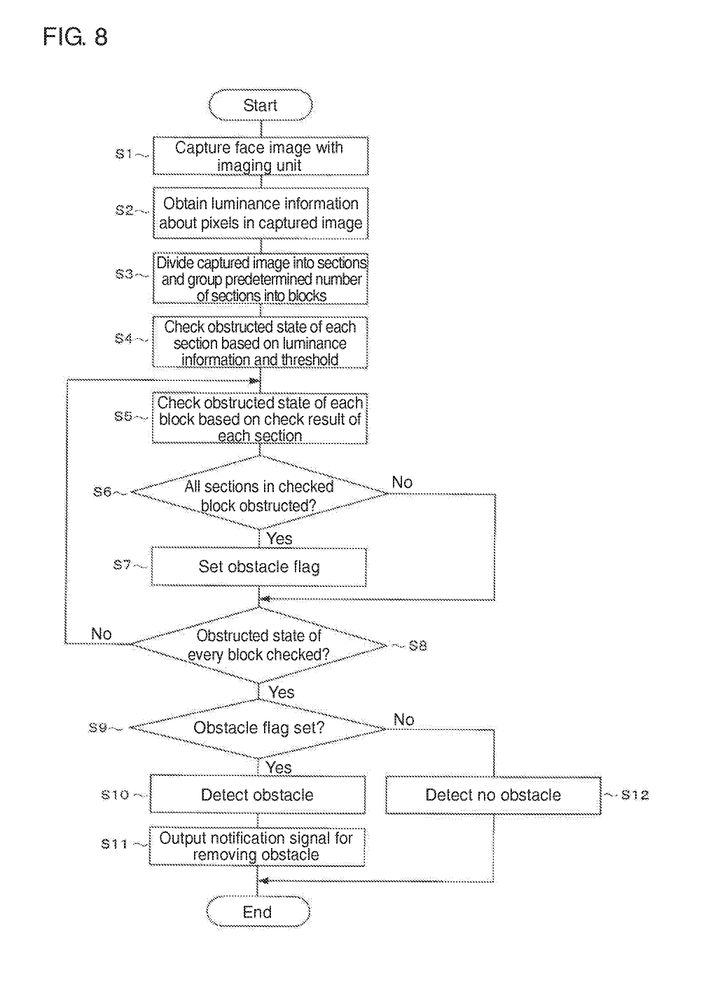

FIG. 8 is a flowchart of an obstacle detection procedure in the driver monitor 100.

In step S1 in FIG. 8, the imaging unit 1 captures an image of the face of the driver 53, who is a subject. In step S2, the image processor 2 obtains luminance information about the pixels m in the image P captured by the imaging unit 1. In step S3, the image processor 2 divides the captured image P into multiple sections Y and groups a predetermined number of sections into each individual block (blocks A to D) as shown in FIG. 3. Subsequently, the obstacle detector 4 performs the processing in steps S4 to S11.

In step S4, the obstacle detector 4 checks the obstructed state of each section (#1 to #16) based on the luminance information obtained in step S2 and the above threshold. In step S5, the obstacle detector 4 checks the obstructed state of each block (A to D) based on the check results of each section.

In step S6, the obstacle detector 4 determines whether all the sections included in each block are obstructed. When all the sections are obstructed (Yes in step S6), the processing advances to step S7 to set an obstacle flag. When one or more sections are unobstructed (No in step S6), the processing advances to step S8 without performing the processing in step S7.

In step S8, the obstacle detector 4 determines whether the obstructed state of every block has been checked. When any block has not been checked (No in step S8), the processing returns to step S5 to check the obstructed state of the next block. When the obstructed state of every block has been checked (Yes in step S8), the processing advances to step S9.

In step S9, the obstacle detector 4 determines whether an obstacle flag is set. When an obstacle flag is set in step S7 (Yes in step S9), the processing advances to step S10 to detect an obstacle. In subsequent step S11, the obstacle detector 4 outputs a notification signal for removing the obstacle. The notification signal is transmitted from the signal output unit 5 (FIG. 1) to the ECU mentioned above. In response to the received notification signal, the ECU notifies the driver 53 of the obstacle by displaying a message for removing the obstacle on the screen or by outputting a voice message.

When no obstacle flag is determined to be set in step S9 (No in step S9), the processing advances to step S12 to detect no obstacle. The processing then skips step S11 and ends.

In the present embodiment, as described above, the image P captured by the imaging unit 1 is divided into sections #1 to #16, and the captured image P is also divided into blocks A to D each including a predetermined number of (in this example, four) sections. Then, the obstructed state of each section included in individual blocks A to D is checked. As shown in FIGS. 6A to 6C, when sections in at least one block have an obstructed state interfering with image capturing of the subject (or at least a part of the central area K is obstructed), an obstacle is detected between the imaging unit 1 and the subject. In contrast, as shown in FIGS. 5A to 5C, when the sections in all blocks A to D have obstructed states that do not interfere with image capturing of the subject (or the entire central area K is unobstructed), no obstacle is detected between the imaging unit 1 and the subject.

The obstructed state of each block A to D is checked to detect an obstacle when any obstacle Z interfering with image capturing is between the imaging unit 1 and the face of the driver 53. Such checking detects no obstacle when an obstacle Z between the imaging unit 1 and the face of the driver 53 does not interfere with capturing of a face image. Thus, an obstacle Z interfering with image capturing can be accurately detected as distinguishable from an obstacle Z not interfering with image capturing.

In the present embodiment, blocks A to D each include a part of the central area K. Thus, at least one block with all the sections obstructed causes a part (or the entire) of the central area K to be in an obstructed state, allowing easy and reliable detection of an obstacle interfering with image capturing.

In the present embodiment, as described with reference to FIG. 3, the captured image P is divided into multiple sections within the valid area excluding the side areas of the captured image P. The amount of data to be processed in this case is smaller than when the entire captured image including the side areas is to be processed. The smaller data amount reduces the processing burden on the apparatus.

In the present embodiment, when the presence of an obstacle is detected, or an obstacle Z interfering with image capturing is between the imaging unit 1 and the face, a notification signal for removing the obstacle Z is output. In response to the signal, the driver 53 can quickly find and remove the obstacle Z.

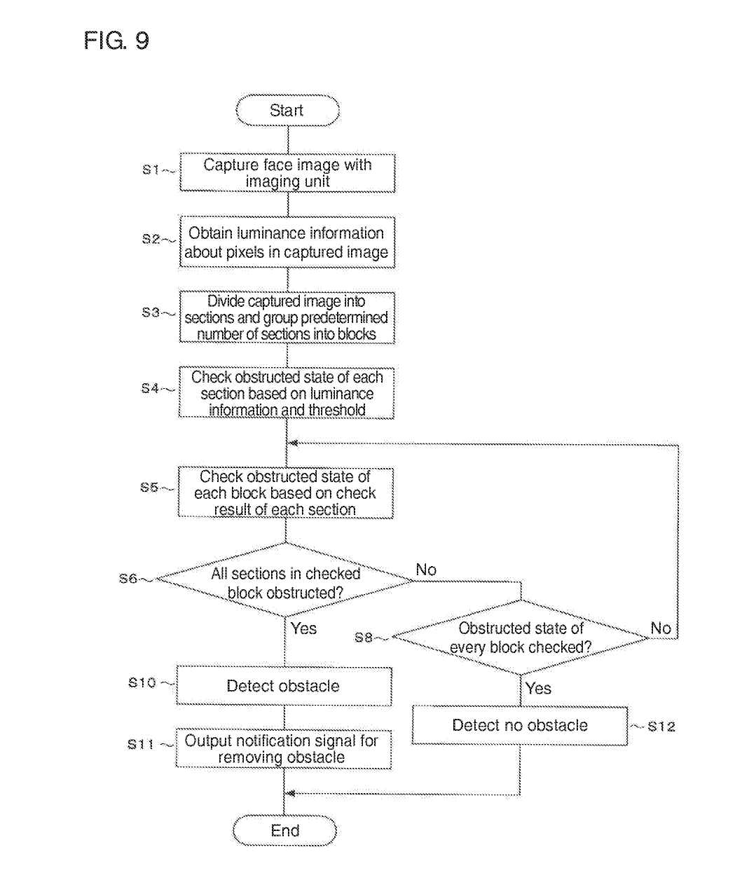

FIG. 9 is a flowchart of another example of the obstacle detection procedure. In FIG. 9, the same processing steps as in FIG. 8 are given the same reference numerals. In the above flowchart of FIG. 8, when one block is determined to be obstructed in step S6, an obstacle flag is set in step S7. After the obstructed state of every block is checked, flag detection is performed in step S9. When a set obstacle flag is found, an obstacle is detected in step S10.

In contrast, the flowchart of FIG. 9 eliminates steps S7 and S9 shown in FIG. 8. When one block is determined to be obstructed in step S6, the processing directly advances to step S10 to detect an obstacle. More specifically, once all the sections in any block are determined to be obstructed, an obstacle is detected, and the driver is notified to remove the obstacle in step S11. This process shortens the time for notification to remove the obstacle.

The present invention may not be limited to the above embodiment but be implemented in various other embodiments described below.

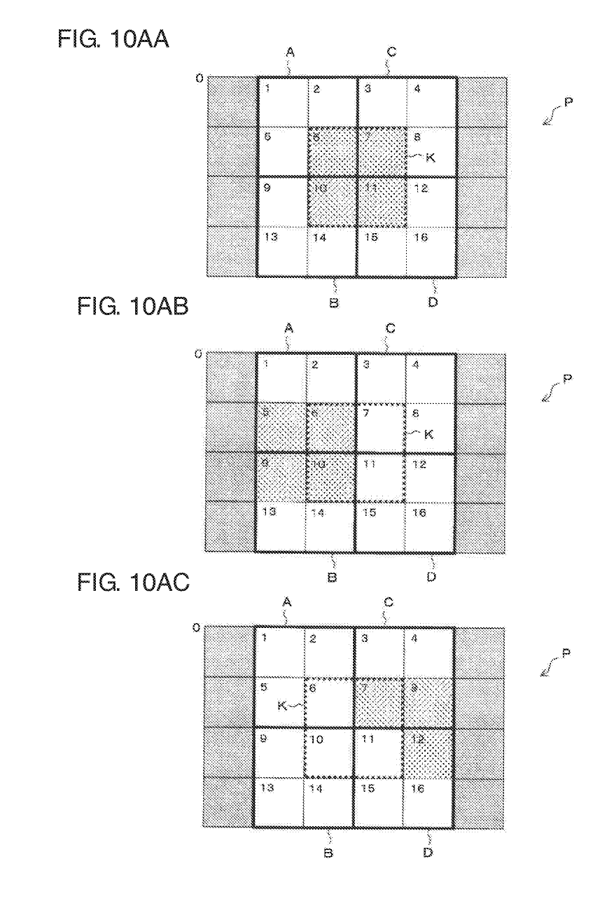

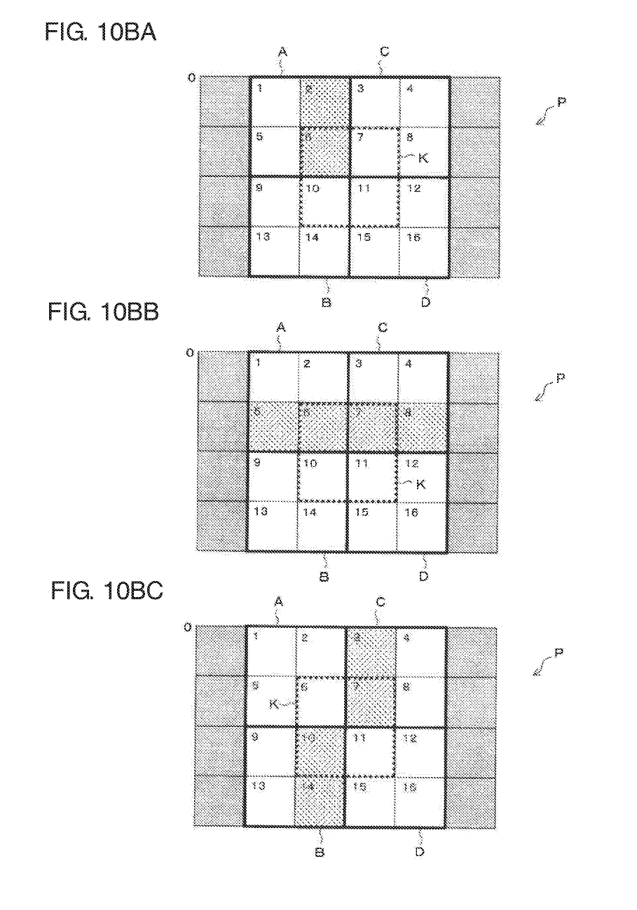

In the above embodiment, FIGS. 6A to 6C show example obstructed states of blocks A to D in which an obstacle is detected. However, an obstacle may also be detected in, for example, obstructed states shown in FIGS. 10AA to 10AC and FIGS. 10BA to 10BC. In FIGS. 6A to 6C, when all the four sections in at least one block are obstructed, an obstacle is detected. However, in FIGS. 10AA to 10AC and 10BA to 10BC, when a section included in the central area K in at least one block is obstructed, an obstacle is detected. Additionally, examples of obstructed states may include various other patterns.

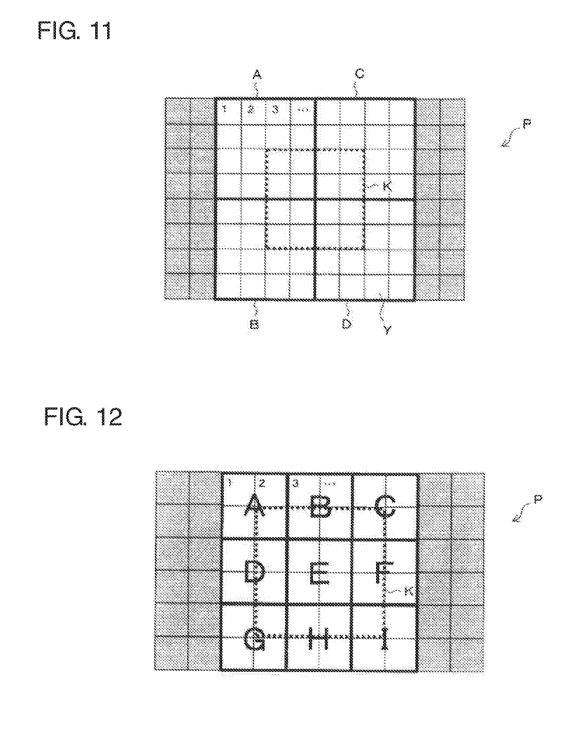

In the above embodiment, the captured image P is divided into 16 sections (FIG. 4). However, the captured image P may be divided into any number of sections. For example, as shown in FIG. 11, the captured image P may be divided into 64 smaller sections. In FIG. 11, blocks A to D each include 16 sections, four of which are included in the central area K. In this example, an obstacle may be detected when all the four sections in one block included in the central area K are obstructed or when one or more of the sections included in the central area K are obstructed.

In the above embodiment, the captured image P is divided into four blocks A to D (FIG. 3). However, the captured image P may be divided into any number of blocks. For example, as shown in FIG. 12, the captured image P may be divided into nine blocks A to I. At least one section included in each block is included in the central area K.

In the above embodiment, the central area K is defined as a square area (FIG. 4). However, the central area K may be, for example, rectangular, rhombic, oval, or circular.

In the above embodiment, the specific area containing the specific part of the subject is the central area K at the center of the captured image P. However, the specific area may be shifted from the center of the captured image P to any predetermined position depending on the subject.

Although the imaging apparatus according to the embodiment of the present invention is the driver monitor 100 installed in a vehicle, the present invention may also be applied to an imaging apparatus used for applications other than a vehicle.

1. An imaging apparatus, comprising:
an imaging unit configured to capture an image of a subject;
an image processor configured to process the image captured by the imaging unit; and
an obstacle detector configured to detect an obstacle between the imaging unit and the subject based on the captured image processed by the image processor,
wherein the image processor divides the image captured by the imaging unit into a plurality of sections, and divides the captured image into a plurality of blocks each including a predetermined number of sections,
the obstacle detector checks an obstructed state of each section in each of the blocks, and detects the obstacle when the obstructed state of each section in at least one block interferes with image capturing of the subject.

2. The imaging apparatus according to claim 1, wherein
the obstacle detector detects the obstacle when all the sections in at least one block are obstructed.

3. The imaging apparatus according to claim 1, wherein
each of the blocks includes a part of a specific area containing a specific part of the subject in the captured image, and
the obstacle detector detects the obstacle when at least one section in the specific area is obstructed.

4. The imaging apparatus according to claim 3, wherein
the obstacle detector detects no obstacle when all the sections in the specific area are unobstructed.

5. The imaging apparatus according to claim 3, wherein
the specific part is a face of the subject, and
the specific area is a central area of the captured image.

6. The imaging apparatus according to claim 1, wherein
the obstacle detector compares luminance of a plurality of pixels included in one section with a threshold pixel by pixel, and determines that a section including at least a predetermined number of pixels with a result of the comparison satisfying a predetermined condition is an obstructed section.

7. The imaging apparatus according to claim 1, wherein
the image processor defines an area excluding side areas of the captured image as a valid area, and divides the captured image within the valid area into a plurality of sections.

8. The imaging apparatus according to claim 1, wherein
the obstacle detector outputs a notification signal for removing the obstacle when detecting the obstacle.

9. The imaging apparatus according to claim 1, wherein
the imaging unit is installed in a vehicle to capture a face image of an occupant of the vehicle, and
the obstacle detector detects an obstacle between the imaging unit and the face of the occupant.
